(19) United States
(12) Patent Application Publication
(10) Pub. No.: US 2008/0261004 A1
(43) Pub. Date: Oct. 23, 2008

(54) Textile Surface Coverings and Methods for Making Them

(76) Inventors: Kenneth B. Higgins, Lagrange, GA (US); Julie Anne Osladil Smallfield, Woodruff, SC (US); Yang Song, Hillsboro, OR (US); Peter C. Brazier, Bedfordshire (GB)

Correspondence Address: Legal Department (M-495), P.O. Box 1926, Spartanburg, SC, 29304, US

(21) Appl. No.: 11/793,073

(22) PCT Filed: Dec. 16, 2005
(86) PCT No.: PCT/US05/45891

§ 371 Date: Apr. 25, 2008

Related U.S. Application Data
(60) Provisional application No. 60/636,728, filed on Dec. 16, 2004.

(51) Int. Cl. B32B 5/16; B05D 3/02

(52) U.S. Cl. 428/206; 427/372.2

(57) ABSTRACT

A surface covering having a decorative show surface and particle backing structure. The show surface is preferably a printed or dyed textile or fabric. The show surface decorative textile is optionally saturated with a protective composition. The backing may be resilient.

### RELATED APPLICATIONS

This application is a United States national application of PCT/US2005/045891, filed Dec. 16, 2005, which claims the benefit of and priority to U.S. Provisional Application No. 60/636,728, filed Dec. 16, 2004.

### TECHNICAL FIELD

The present invention relates to surface coverings having a textile show surface optionally saturated with a protective coating composition in overlying relation to a backing of agglomerated adjoined particle elements. In particular, but not exclusively, the invention relates to a surface covering such as a carpet, carpet tile, flooring, floor tile, floor covering, floor mat, roll goods, modular product, or the like. The surface covering may incorporate a knit, woven or non-woven decorative textile layer. The textile layer may be saturated with a film-forming composition which is desirably transparent or translucent when cured. It is additionally desirable that the film-forming composition or one or more wear layers is wear resistant, soil resistant or stain resistant. In one embodiment, the textile face may be disposed in overlying relation to a resilient backing formed from an agglomerated mass of particles, such as fractal particles, for example particles of virgin, recycled, recyclable, renewable, and/or other environmentally friendly materials, such as foam and/or rubber and/or cork. The textile face and the resilient backing will generally be bonded together in adjoined relation. An optional textile backing layer may be disposed across the underside of the resilient backing. Friction enhancing, adhesive, or installation facilitating materials may be added to and/or on the underside of the backing. For example, the particle backing may include voids which increase lateral grip, reduce creep, and the like. Methods of making such surface coverings are also provided.

### BACKGROUND TO THE INVENTION

It is known to provide carpeting and carpet tile with tufted or bonded carpet faces and with backing layers formed from so-called “virgin” or “filled” foam or from “rebond” foam wherein irregular pieces of recycled foam chips are held together by a resilient binder. Such virgin or filled foam carpet constructions are described, for example, in U.S. Pat. Nos. 5,545,276; 5,948,500; 6,203,881; and 6,468,623 each hereby incorporated by reference herein. Such rebond foam carpet constructions are disclosed for example in U.S. patent application Ser. Nos. 09/721,871 and 09/993,158 (US Published Application US 2002/0132085) and 10/209,050 (US Published Application US 2004/0022991) and British patent GB 2369294 to Higgins et al. which are hereby incorporated by reference as if fully set forth herein.

Also, floor coverings in the form of mats having a textile surface and a rubber backing are well known. Typically, such mats include a tufted pile textile surface, for example of nylon, cotton, polypropylene, or a mixture of such fibres, which is bonded to a rubber backing sheet. Such mats are usually made by bonding the textile surface layer to a sheet of uncured rubber in a heated press. The heat from the press vulcanises (cures) the rubber and at the same time bonds it to the textile layer. Such mats have very good dust control characteristics, are highly effective at removing dirt and moisture from the feet of pedestrians, and have a good feel and appearance. The mats are also washable, extremely durable, highly flexible and lie flat on the floor.

One disadvantage of the mat constructions described above is that they tend to be rather expensive, owing to the relatively high cost of the virgin rubber backing material. Moreover, there is a general desire by manufacturers and users to increase the recycled content of manufactured products. Recycled rubber has been used effectively as a low cost substitute for virgin rubber in certain mat production processes. For example, a mat with a compression moulded rubber crumb backing and having a flock surface applied to the backing is available under the brand name “Royal Mat”. The compression moulded backing is made by mixing rubber crumb with a binder and then compressing a layer of the mixture in a mould at a high pressure while the binder bonds the crumbs together. The flocked textile surface is subsequently applied to the backing using an adhesive.

### SUMMARY OF THE INVENTION

The present invention provides advantages and alternatives over the prior art by providing a surface covering such as a carpet, carpet tile, flooring, floor tile, floor covering, floor mat, roll goods, modular product, and the like incorporating a decorative textile face defining a show surface and a particle backing of, for example, virgin, recycled, recyclable, and/or renewable materials, such as particles or crumbs of rubber, foam, cork, and/or the like. The decorative face of such surface coverings is preferably formed from a flat fabric or textile of woven, knitted, or nonwoven construction. A decorative image such as a printed text, design, color, image, or pattern may be applied to the textile face by printing or dyeing. Optionally after being printed or dyed, if desired, the decorative face fabric may be saturated or coated with an effective film-forming amount of protective film-forming composition, for example, a transparent or translucent wear resistant, stain resistant or soil resistant composition such as a polyurethane, more desirably a clear polyurethane, acrylic, or polyester. If desired a stabilizing layer for example constructed of glass may be employed on or in or for the backing. In one possibly preferred construction, the stabilizing layer may be embedded within the backing. A textile backing layer may also be applied across the underside of the particle backing. A friction enhancing coating or material may be added across the underside of the particle backing or the underside of the textile backing.

According to one aspect of the present invention, there is provided a method of making a surface covering with a textile surface and a resilient backing having a substantial percentage of recycled material. In a potentially preferred practice, the method includes mixing particles, for example particles of rubber and/or foam and/or cork with a binder optionally with the addition of one or more fillers, agents or compounds, depositing the particle/binder mixture in a layer, placing a coated textile surface material on the layer to form a multi-layer structure, pressing the multi-layer structure while setting the binder with, for example, heat so that the particles are consolidated to form a resilient backing. Generally the resilient backing will include voids between the pressed particles. The coated textile surface material will be bonded to the backing. The coated textile surface material may be printed or dyed before or after it is coated. One or more additional protective, stain resistant, soil resistant, or wear layers may be added over the coated textile surface material.

Throughout this specification the terms “particles”, “powder”, “granules”, “chips” or “crumbs” are used to designate elements of virgin, renewable, recycled, recyclable, and/or other environmentally friendly materials, such as elements of cork, foam, rubber, flooring, and/or the like that have been “broken down” by chopping, mechanical grinding, cryogenic grinding, or other known technique or suitable combination techniques as will be known to those of skill in the art. Thus, a particle or crumb of cork, foam, or rubber utilized within the contemplated practices can be any size in a range that includes powder, granules and chips. For the purpose of describing at least selected embodiments of the present invention, the term “powder” means particles or crumbs that will pass a 2 mm mesh or with a maximum dimension of 2 mm in at least one dimension as the context requires. “Granule” or “granules” means particles or crumbs that will pass a 6 mm mesh or with a maximum dimension of 6 mm in at least one dimension, as the context requires. Granules may include some powder but are generally larger than powder and have a weight average size that is near to the maximum of the size specification for the granule. “Chips” means particles or crumbs that are larger than granules. That is, larger than 6 mm in at least one dimension as the context requires. Regardless of actual dimension, it is contemplated that the particles or crumbs are preferably characterized by substantially fractal irregular surface configuration.

It should be noted that any batch of particles normally contains a proportion smaller than the nominal particle size. Thus, for example, it has been found that rubber particles made using a granulator with a 1.5 mm screen (i.e. having holes of diameter 1.5 mm) had a distribution of sizes, measured by using standard “Endecott” test sieves (ISO3310-1:2200, BE410-1:2000, ASTM E11:95), comprising by weight 72.82% in the range 1.0-2.0 mm, 17.45% of 0.71-1.0 mm, 6.90% of 0.5-0.71 mm, 2.65% of 0.25-0.5 mm and 0.18% of 0-0.25 mm. Therefore, in the present specification, where we refer to 1.5 mm crumb or particle size, it is meant that the particles are generated using a granulator with a 1.5 mm screen. Likewise, it is to be understood that where reference is made to “setting” the binder, we mean any suitable method of setting the binder, for example using techniques such as curing, hardening, fixing, or heat-setting the binder. The skilled person will know which method of setting to use, usually depending on the nature of the binder. The binder may be selected from the group including thermosetting and water curable polymeric materials, adhesives, and mixtures thereof. The binder may alternatively be selected from the group including thermoplastic polymeric materials, hot melt binders, adhesives and mixtures thereof.

According to another contemplated practice, the assembled layers are pressed at a temperature of from about 50° C. to about 200° C., preferably from about 110° C. to about 180° C., and most preferably approximately from about 125° C. to about 177° C.

The assembly may be pressed in a plurality of stages including a low temperature stage and a higher temperature stage. Depending on requirements, the low temperature stage may be employed first with a later higher temperature stage or vice versa. For example, if the binder is selected from the group including thermosetting and water curable polymeric materials and mixtures thereof, the assembly is preferably pressed in a plurality of stages including at least one low temperature stage followed by at least one higher temperature stage. Alternatively, for example if the binder is selected from the group including thermoplastic polymeric materials, hot melt binders and mixtures thereof, the assembly is preferably pressed in a plurality of stages including at least one high temperature stage followed by at least one lower temperature or cooling stage.

The assembly may be pressed between a pair of opposing compressive belts (double belt laminator) although other equipment such as a press having an inflatable diaphragm may likewise be used when it is desired to cure the assembly under pressure.

A continuous sheet of textile material may be laid on the particle/binder layer. The textile material being laid is optionally a saturated or coated textile material. Alternatively, or additionally to the continuous sheet, separate textile elements may be laid consecutively on the particle/binder layer. If desired, a layer of adhesive such as a resilient adhesive may be disposed between the textile face and the particle/binder layer, between the textile face and a stabilizing layer or material and/or between a stabilizing layer or material and the particle/binder backing to facilitate adhesion.

In the event that rubber particles are used, such rubber is preferably EPDM or nitrile rubber. EPDM is a term used to designate a rubber mixture of which the main polymeric content is an ethylene propylene diene rubber monomer. It may also have fillers, plasticisers and other ancillary components as will be known in the rubber compounding industry. The EPDM particles may be either foam or solid particles. Nitrile rubber is a term used to describe a compounded rubber mixture of which the main polymeric content is an acrylonitrile butadiene copolymer. It may also contain one or more of fillers such as carbon black, a curing system, plasticisers and other ancillary components. Other rubber materials such as SBR rubber particles may also be used.

In the event that foam particles are used, such foam is preferably a urethane foam or an EPDM foam. Such foams, and in particular urethane foams, may be mechanically frothed and/or chemically blown and may be of either open or closed cell construction. Other foams such as rebond foam, waste rebond foam, nitrile foam, SBR foam, and the like may also be used.

In at least one embodiment, the particle/binder backing has a density of less than about 1 g/cm³. The particle/binder backing preferably has a density in the range from about 0.5 to about 0.9 g/cm³, more preferably from about 0.7 to about 0.9 g/cm³.

In at least one embodiment, the particle/binder backing exhibits a tear resistance strength of at least about 0.8N/mm2. More preferably the tear resistance strength of the particle/binder backing is about 1.5N/mm2 or higher.

Advantageously, the textile surface or face comprises a relatively flat textile construction, for example, of a nonwoven, knitted or woven textile construction. Such materials may be formed, woven, knit, printed or jet dyed with decorative surface designs if desired. The textile material is preferably saturated with a clear protective film-forming composition such as polyurethane, acrylic, polyester, or the like (preferably at least transparent or translucent after curing). The textile material may be saturated before or after printing, dyeing, texturing, backing, or the like. In at least one embodiment, the textile material is preferably printed or dyed prior to being saturated. Using one or more sublimation printing techniques, the textile material may be printed after being saturated or coated, for example, with a transparent material. Full saturation or fully saturated means saturated, penetrated or soaked through the textile and covered sufficiently to form a protective, outer film, coating, or the like. The textile surface or face may be saturated or coated all at once by, for example, a dip coater, or may be coated and saturated by being coated on one side and then the other (top and bottom), for example, by a roll coater on each side followed by a nip roller. Full saturation may be accomplished in multiple steps or a single step. Further, one material may be coated on the bottom of the textile, such as an opaque hot melt, adhesive, latex material or MDI binder, and another material on the top of the textile, such as a transparent polyurethane, polyester, acrylic, or the like. Hence, the textile face or surface material may be coated or saturated with one or more materials in one or more steps. One or more additional preferably transparent stain resist, soil resist, and/or wear layers may be added over the coated textile surface material.

### BRIEF DESCRIPTION OF THE DRAWINGS

The invention will now be further described by way of example only and with reference to the drawings, which are briefly described as follows:

FIG. 1 is a cross-sectional side elevation of an exemplary surface covering element having a fabric show surface and illustrating layered constituent elements and an optional additional protective layer;

FIG. 2 is a side elevation of a process line for manufacturing a surface covering, such as the surface covering of FIG. 1 as well as others, incorporating, for example, a fabric show surface and a particle backing, such as a rubber particle backing;

FIG. 2A is a view similar to FIG. 2 illustrating a process line for manufacturing a surface covering, such as the surface covering of FIG. 7 with or without the textile backing 452, incorporating, for example, a fabric show surface, an optimal adhesive layer, and a preformed particle backing such as a rebond foam backing;

FIG. 2B is a view similar to FIG. 2 illustrating an alternative process line for manufacturing a surface covering, such as the surface covering of FIG. 1 as well as others, having a fabric show surface and a particle backing;

FIG. 3 is a cross-sectional side view similar to FIG. 1 illustrating an alternative exemplary surface covering element having a fabric show surface adhesively bonded to a stabilized particle backing with an underlying backing sheet;

FIG. 4 is a side elevation of a process line for manufacturing a surface covering, such as a surface covering having the layered construction illustrated in FIG. 3, incorporating a fabric show surface adhesively bonded to a stabilized particle backing such as a rubber particle backing;

FIG. 4A is a view similar to FIG. 4 illustrating a process line for manufacturing a surface covering having, for example, the layered construction illustrated in FIG. 3, incorporating a fabric show surface adhesively bonded to a stabilized preformed particle backing such as a rebond foam backing having, for example, two preformed rebond foam layers;

FIG. 5 is a cross-sectional side view of a surface covering similar to FIG. 1 illustrating the inclusion of a textile backing such as a fibrous backing sheet;

FIG. 6 is a cross-sectional side view of a surface covering similar to FIG. 3, FIG. 5, or FIG. 7 illustrating an exemplary alternative surface covering element having a fabric show surface adhesively bonded to a stabilized particle backing with an underlying backing sheet;

FIG. 7 is a cross-sectional side view of a surface covering similar to FIG. 3, FIG. 5 or FIG. 6 illustrating an exemplary surface covering element having a fabric show surface adhesively bonded to a particle backing with an underlying backing sheet;

FIG. 8 is a cross-sectional side view of a surface covering similar to FIG. 1, FIG. 5 or FIG. 7 incorporating a layer of adhesive bonding a fibrous backing sheet;

FIG. 9 is a cross-sectional side view of a surface covering similar to FIG. 8 or FIG. 7 incorporating a layer of adhesive on either side of a backing layer;

FIG. 10 is a cross-sectional side view that illustrates a surface covering construction similar to FIG. 6 incorporating a combination of stabilizing layers such as glass and scrim stabilizing layers;

FIG. 11 is a cross-sectional side view of a surface covering similar to FIG. 3 but excluding adhesive additions;

FIG. 12 is an elevation plan view of a surface covering such as a tile product incorporating a decorative show surface and optional additional protective layer and texturing such as embossing;

FIG. 13 is a side view taken along line 13-13 in FIG. 12;

FIG. 14 is an elevation plan view of a surface covering such as a tile product incorporating a decorative show surface with outboard border zones and optional additional protective layer and texturing such as embossing; and,

FIG. 15 is a side view taken along line 15-15 in FIG. 14.

### DESCRIPTION OF PREFERRED EMBODIMENTS

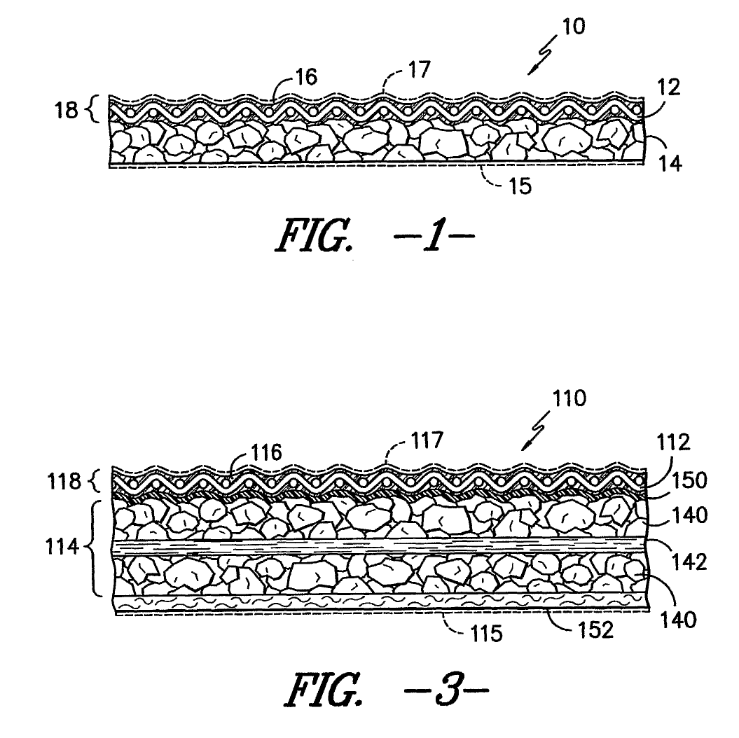

With reference to FIG. 1 of the drawings, an exemplary embodiment of a surface covering 10 such as a carpet, carpet tile, flooring, floor tile, floor covering, floor mat, roll goods, modular product, or the like is illustrated in cross section. As will be appreciated, for ease of understanding, the various layers are illustrated with enhanced dimensions. Thus, the illustrated dimensions do not necessarily correspond to final relative thickness levels in the layers or final construction.

As shown, in the illustrated exemplary embodiment of FIG. 1, the surface covering 10 includes an exterior composite layer 18 including a textile show surface 12 of preferably substantially flat woven, nonwoven or knit fabric or textile construction preferably saturated with a wear resistant film-forming composition 16 that defines an encapsulating protective barrier across the textile show surface 12. Composite 18 may include one or more additional protective, wear, stain resist, soil resist, and/or the like layers, films, coatings or like 17 preferably transparent or translucent at least when cured. The exterior composite layer 18 is disposed in overlying relation to a single or multi-layer backing structure 14 as will be described further hereinafter incorporating an agglomerated mass of particles such as virgin, recycled, recyclable, renewable, and/or other environmentally friendly materials, for example, recycled flooring and/or foam and/or rubber and/or cork particles. As will be appreciated, the term “flat” used in reference to the textile show surface is intended to refer to the preferably non-pile face contour of the show surface 12 rather than to any particular formation technique. In this regard, it is to be understood that flat fabrics may include relatively level low profile face fabrics such as plush, napped or sanded face fabrics. Textile or fabric 12 may be mesh, net, open weave, tight weave, short loop, short tight loop, short pile, very short pile, needled, bonded, tufted, flocked, woven, nonwoven, knit, and/or the like. By way of example only, and not limitation, one process for forming a knit or knitted plush fabric is disclosed in U.S. Pat. No. 5,916,273 the contents of which are incorporated herein by reference. Fabrics of the type disclosed in U.S. Pat. No. 5,916,273 are suitable for use with the present invention. While ribbed fabrics may be used if desired, fabrics with substantially level surfaces such as plain woven, flat woven, nonwoven, needled, and warp knit fabrics may be preferred. Of course, such fabrics necessarily have some degree of irregularity across the surface due, for example, to yarn cross-over points, embossing, and the like. The show surface 12 is visible through the preferably transparent or translucent film formed by the saturating film-forming composition 16 and any additional layers 17 and is thus visible to a user.

In at least selected embodiments, the textile show surface 12 is preferably a woven or knit material such as a polyester of multi-filament spun yarn construction and more desirably of the type wherein the yarns are characterized by linear density levels in the range of from about 50 to about 2500 denier. By way of example only, one contemplated textile show surface is an office panel fabric of woven jacquard construction formed from 150 denier textured polyester with a formation construction of about 128 ends per inch (2.54 cm) by about 42 picks per inch (2.54 cm) with a mass per unit area of about 6.1 ounces per square yard (205.88 grams/m2) prior to saturation. Another contemplated textile show surface is an office panel fabric of woven jacquard construction formed from 150 denier textured polyester yarn with a formation construction of about 132 ends per inch (2.54 cm) by about 51 picks per inch (2.54 cm) with a mass per unit area of about 5.4 ounces per square yard (182.25 grams/m2) prior to saturation. Still another contemplated textile show surface is a seating fabric of knit construction formed from 1/800/1 elastomeric polyester in combination with 3/150/36 textured polyester with a formation construction of about 14 wales per inch (2.54 cm) by about 20 courses per inch (2.54 cm) with a mass per unit area of about 13.5 ounces per square yard (455.63 grams/m2) prior to saturation. The textile show surface 12 may be either of solid coloration or may have a decorative coloration, image, design, or pattern woven, tufted, formed, printed or dyed thereon. For example, a pattern, design, color, shade, or the like may be formed by using colored fibers or yarns such as yarn dyed or solution dyed, formed by piece dyeing, formed by printing or may be jet dyed on the textile show surface 12 made for example from white or light or light colored yarn or fiber. Any printing, dyeing or other coloration is desirably done prior to saturation. Alternatively, one or more sublimation printing techniques may be used to print or dye the textile show surface after saturation.

As previously indicated, the textile show surface 12 is preferably saturated, penetrated, encapsulated, or covered with a preferably wear resistant see-through film formed from a suitable film-forming composition 16 and one or more optional additional layers, films, coatings, or the like 17 that defines an encapsulating protective barrier across the textile show surface 12. The terms “full saturation” or “fully saturated” as employed herein with reference to the present invention are used to indicate that an amount of film-forming composition effective to saturate, penetrate, or soak through the textile or fabric 12 and to form a film on both sides is employed. To establish an effective barrier, the film-forming composition 16 is preferably applied at a level sufficient to fully saturate the textile thereby forming at least a thin film across both sides (face and back) of the fabric forming the textile show surface 12. Full saturation and penetration is preferred as it may prevent shade variations, strengthen the face, enhance durability, enhance dimensional stability, and/or the like. The film forming composition 16 and any additional layers 17 are preferably sufficiently transparent in a final cured state so as to avoid interference with the decorative character of the textile show surface. The film-forming composition is preferably a liquid for example a urethane or acrylic such as is readily available for coating hard wood floors and the like although other suitable transparent or translucent protective film forming compositions such as polyester or the like may likewise be utilized if desired. The add on weights should preferably be adequate to fully saturate and penetrate the textile show surface material thereby surrounding and encapsulating such textile show surface material.

As previously indicated, the backing structure 14 preferably is formed from a mass of particles, such as renewable, recyclable, and/or recycled solid or foam particles, such as cork and/or foam and/or rubber and/or other particles attached together using a binder material such as a resilient or hard binder that bonds each particle to adjacent particles alone or together with other materials, agents, fillers, additives, and/or the like. The particles are preferably of a substantially irregular fractal surface geometry to provide a high surface area for bonding. However, spheroidal, pellet, cylindrical, disc, rod, and/or other relatively smooth surface geometries may be used if desired. For example, compressible and/or noncompressible spherical particles such as rubber or ceramic spheres may be employed. In the embodiment illustrated, the binder also bonds the backing structure 14 to the protective or film-forming composition 16 on the underside of the exterior composite layer 18. As will be appreciated, within the backing structure interstitial voids exist between the particles, some of which may be partially or fully filled with the binder, fillers, additives, etc. If desired, maintaining voids and/or using a resilient binder may provide substantial resiliency and cushioning. A certain number of voids may also reduce mass, reduce cost, increase flexibility, enhance lateral grip, reduce creep, and/or the like. At least when using a liquid binder, it is preferred that each of the particles of the backing be encapsulated with at least a thin layer of binder. This aids in bonding the particles together and in bonding the backing 14 to the face composite 18.

In the event that the particles of the backing structure are rubber, nitrile rubber or EPDM may be preferred. By way of example, one contemplated source of EPDM is recycled weather stripping. Such EPDM may be either of hard or resilient (foam) character. By way of example only, one contemplated source for nitrile rubber is from recycled industrial mats. The rental industrial segment is an ideal source of raw material for the rubber particles because it ensures that low bleed, low staining nitrile rubber is used as the starting point for the production of the surface coverings. Rubber from recycled tires may also be used if desired. Recycled SBR rubber may also be used. In the event that the particles of the backing structure are foam, cellular polyurethane foam may be preferred. Other rubber materials (solid or foam) may be used.

It is contemplated that the size of backing structure particles, such as foam, rubber or cork particles, utilized should preferably range from about 0.01 to about 15 mm. However, larger particle sizes may be used if desired. Generally, the size is selected to be as large as possible for the use and properties required. It has been found that particle size can be chosen to give different amounts of resilience in the product. Larger particles generally provide greater resilience. Particles of a desired size may be mixed with powder of the same material or a different material to provide a greater tear resistance. Powder may increase the tensile strength for a given binder level. The use of other additives in powdered or liquid form may provide the same or different advantages. Suitable additives include, but are not limited to, anti-microbial materials, anti-flammability additives, odorants, colorants or pigments such as iron oxide powder, anti-static additives such as carbon fibres, fillers and/or other generally known additives.

Also, one may combine hard and resilient chips, particles or crumbs of the same material or different materials. For example, one may mix foam EPDM particles with solid filler particles and with binder.

The binder used to adjoin the particles of backing 14 may be either a water curing, heat setting or thermoplastic type. Depending on the process utilized to manufacture the backing, the binder can be in liquid or powder form. Preferably, the binder is selected from one of the following types: polyurethane reactive hot melts, copolyester or copolyamide reactive and thermoplastic hot melts, and 4,4-methylene di-p-phenylene isocyanate (MDI) polyurethane one- and two-component adhesives.

It is important that the binder has good adhesive properties to ensure that the particles are well bound, and it is additionally desirable that sufficient free binder is provided to be capable of forming a physical or chemical bond to the exterior surface of, for example, face composite 18, stabilizing layer 142, backing 152, and/or the like. The binder should also desirably exhibit sufficient cohesive strength to give the backing sufficient strength. The binder may contain any of the known cross linkers or curing accelerators to suit the process and the desired properties of the product being manufactured and the particles being used.

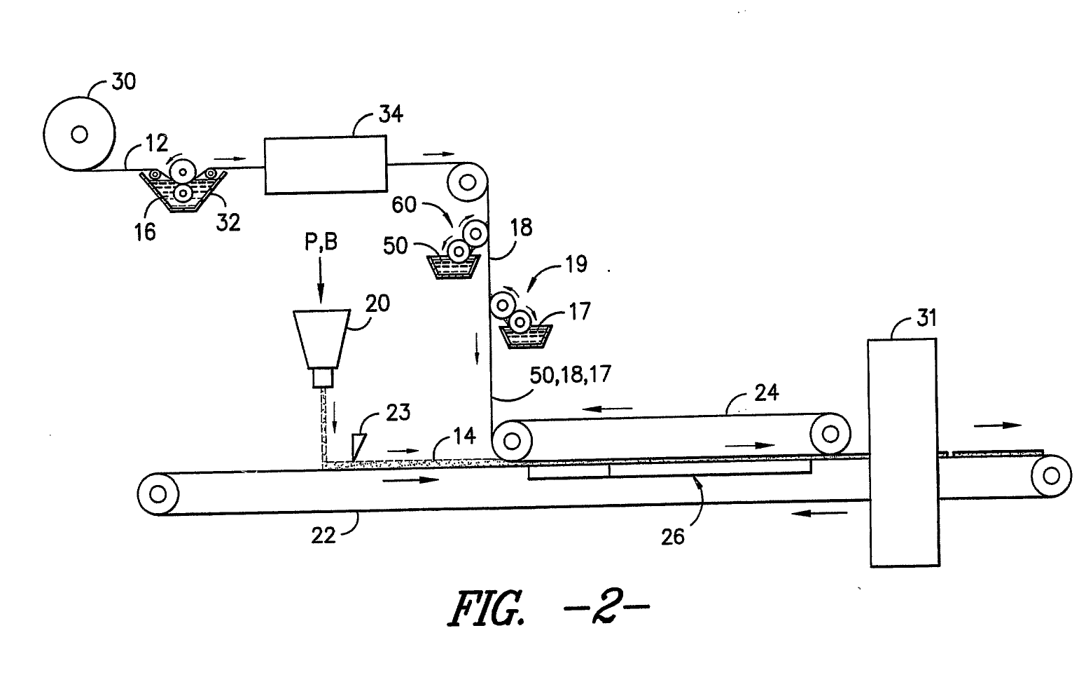

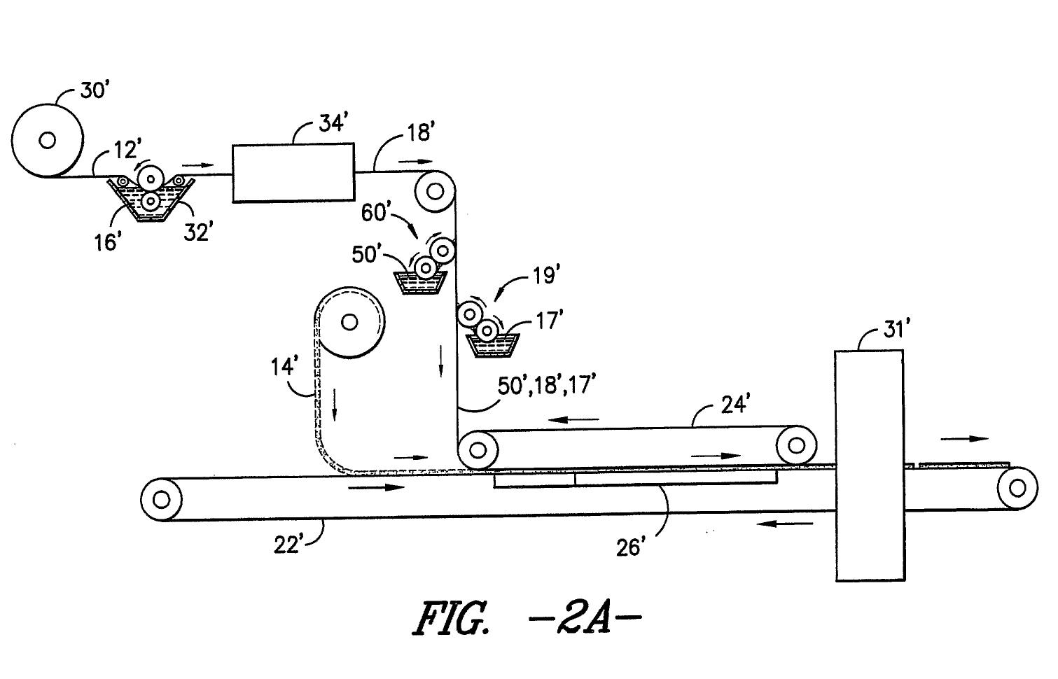

In the illustrated embodiment of FIG. 1 (and with reference for example to FIGS. 2 and 2B), the binder performs the dual function of holding together the particles to form a backing 14 and bonding the backing 14 to the bottom of the exterior of composite layer 18. To perform both functions, binder levels should preferably be in the range from about 2 to about 20% by weight of the particles. Use of lower particle sizes may dictate the use of higher percentages of binder due to greater surface area. In particular, the use of fine powders of size less than about 0.5 mm may require about 20% binder or more.

Generally, there is an inverse relationship between the binder content and size of the particles and between the binder content and pressure applied to the binder/particle mixture while forming the backing structure 14. Therefore, as the particle size and the pressure increase, the binder content normally decreases. The binder content also depends on other factors, such as the type of binder, the particle material used and the type of fabric, and can be determined by routine experimentation.

For example, the binder may be a liquid polyurethane MDI binder, in which case it is preferably present at a level of from about 4 to about 12% by weight for example if the backing consists primarily of chips or granules. The binder may contain further additives that are desirably in liquid form and which are compatible with the binder, such as colorants, plasticizers and perfumes. The binder may also contain other additives provided that they are suitable for addition in a liquid medium.

The binder may alternatively be a thermoplastic or thermosetting hot melt powder, in which case it is preferably present at a level from about 3 to about 10% by weight, for example if the backing consists primarily of chips or granules. A powdered binder may also contain other additives provided that they are suitable for addition in a powder medium.

In accordance with at least selected embodiments, the preferred ranges for binder content may thus be summarized as follows:

Backing of chips/granules: binder content in range from about 2 to about 20% by weight, preferably from about 4 to about 12% by weight for example with an MDI binder or from about 3 to about 10% by weight for example with a hot melt binder.

Backing with about 10% powder: binder content in range from about 9 to about 20% by weight, preferably about 14% by weight or more.

In exceptional cases, a binder content of about 25% or more by weight may be employed, even though this may lead to the formation of a skin.

A process for making the surface covering 10 of FIG. 1 with a backing structure of, for example, granulated particles of foam, cork or rubber will now be described with reference to FIG. 2, which is a schematic of an integrated processing line. In the illustrated process, a mixture of particles or crumbs, such as foam, rubber or cork particles P in blended relation with a desired binder B is delivered from a deposit station 20 that blends the particles and binder onto a motor driven carrier belt 22. To aid in establishing a uniform deposit of particles and binder across the carrier belt 22, doctor blade 23 or other suitable levelling device is positioned downstream of the deposit station 20.

The carrier belt 22 is made with a non-stick surface, for example, of PTFE-coated woven glass fabric to prevent the applied materials from sticking to it. Alternatively, carrier belt 22 may be coated with a release layer or covered with a liner that facilitates release of the backing therefrom. For example, a backing sheet may be added between belt 22 and backing 14. In use, the carrier belt 22 advances in the direction of the arrows shown. This movement may be either stepwise or continuous depending upon the nature of the product being formed. As illustrated, the carrier belt 22 is disposed in opposing relation to motor driven compression belt 24 which moves in reverse angular relation to the carrier belt so as to establish a nip zone between the belts in the vicinity of heating (or cooling) elements 26. Materials deposited on the carrier belt 22 thus undergo a degree of compression between the carrier belt 22 and the compression belt 24 while simultaneously being heated or cooled.

In the illustrated process, a fabric forming the textile show surface 12 is conveyed from a roll 30 through coater 32 such as a submersion roll coater or the like wherein the film-forming composition 16 is applied in saturating relation to the textile show surface fabric. The film-forming composition is preferably a liquid urethane such as is readily available for coating hard wood floors and the like although polyesters, acrylics and other suitable protective film forming compositions may likewise be utilized if desired. By way of example only, and not limitation, one suitable film forming protective composition is believed to be a polyurethane marketed under the trade designation STREETSHOE SUPER MATTE by Matrix Coatings having a place of business in Des Moines, Iowa. Such a composition has about a 20% by weight solids content and is preferably applied in a wet state at levels of from about 2 to about 100 ounces per square yard (from about 67.5 to about 3375 grams/m2) thereby yielding a dry add on weight after curing of from about 0.4 to about 20 ounces per square yard (from about 13.5 to about 675 grams/m2) in order to establish the desired saturation and film-forming character. Of course, such levels are exemplary only and will depend upon the character of the fabric being saturated or coated. By way of example only, for a woven jacquard construction formed from 150 denier textured polyester yarn with a formation construction of about 132 ends per inch (2.54 cm) by about 51 picks per inch (2.54 cm) and a mass per unit area of about 5.4 ounces per square yard (182.25 grams/m2) prior to saturation it has been found that a wet application of about 8 ounces per square yard (270 grams/m2) yielding a dry add on of about 1.6 ounces per square yard (54 grams/m2) may be desirable.

After exiting the coater 32, the saturated fabric is then passed through a curing station 34 such as a heater, oven, or the like to cure the applied film forming composition 16 to form the exterior composite layer 18 as previously described. The fabric with the cured coating is then delivered in overlying relation to the particle/binder composition on the carrier belt 22 for subsequent compression and heating between the carrier belt 22 and the compression belt 24. Of course, it is to be understood that the coating of the show surface fabric need not be carried out in the same processing line as the heated compression. In fact, such steps are likely to be carried out in separate processing lines to facilitate processing freedom. For example, a roll 30 of saturated fabric 18 may be delivered to the processing line (range) shown in FIG. 2.

With reference again to FIG. 2 of the drawings, roll coater 60, such as a reverse roll coater, or other coating means may be used to add an adhesive or coating 50 to the back of fabric 12 or of saturated fabric 18. Also, roll coater 19, such as a reverse roll coater or other coating means such as an extruder, may be used to add an additional layer 17 to composite 18 or to add material 16 on top of fabric 12, or the like. One or both roll coaters 60 and 19 or roll coater 32 may or may not be used depending on the desired structure. Further, material 16 may be added in one or more steps or layers. For example, coater 32 may add a first coating 16 and coater 19 may add a second coating of material 16. Roll coater 60 may likewise add a second coating of material 16 to the bottom of fabric 12. Hence, each of coaters 32, 60 and 19 may or may not be used and may be used to add material 16, 50 or 17 as desired. It is contemplated that additional ovens, heaters, fans, curing equipment, or the like may be added downstream of coaters 60 and 19 as necessary.

After the exterior composite layer 18 is oriented on top of the particle binder composition, the pressure and heat (or cooling) applied between the opposing belts 22, 24 causes the binder to bond or fuse the particles together thereby forming a stable backing structure 14 of desired thickness and resilience. In this regard, the applied pressure is preferably in the range of from about 0.01 to about 50 pounds per square inch or greater (from about 0.06895 kPa to about 344.75 kPa) and the temperature is preferably from about 300° to about 375° Fahrenheit (from about 148.9° to about 190.6° C.) although higher or lower temperatures may be used depending upon the materials of construction and pressure utilized. The combination of the saturating film-forming composition 16 and the binder B in the backing structure 14 concurrently bonds the exterior composite layer 18 to the backing structure 14. The layered structure formed preferably has the configuration illustrated in FIG. 1. As will be appreciated, a percentage of the exterior composite layer 18 may be depressed into and below the surface of the backing structure 14 if desired. After formation the resultant structure may be delivered to a tile cutter 31 (or rug, runner, or mat cutter) if it is to be used in a modular installation (or as a rug, runner or mat) or accumulated on a roll (not shown) if it is to be used in extended length segments such as roll goods, runners, broadloom, for example, 6 foot wide broadloom or to be cut later.

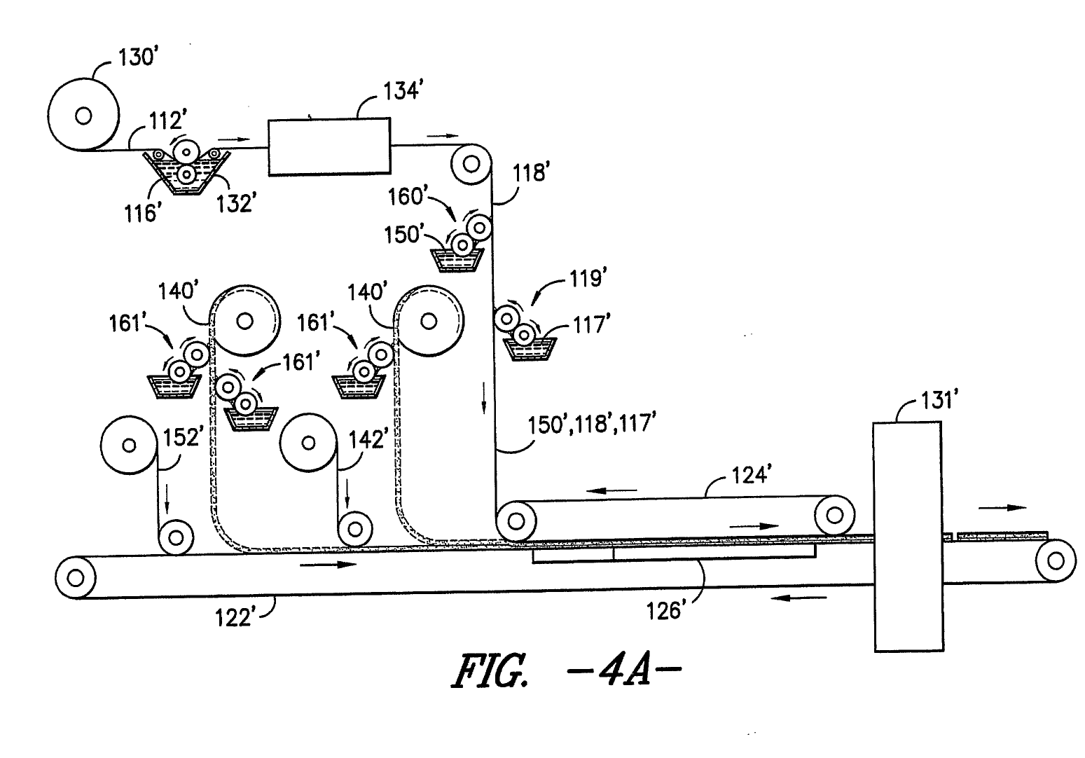

Of course, if desired, an additional layer of adhesive 50 such as hot melt urethane, polyester, polyamide, or the like may be added at the intersection between the particle/binder composition and the exterior composite layer 18. Such an adhesive may further stabilize the structure and provide enhanced protection against delamination. If used, such an adhesive layer may be applied in line such as on the bottom of the exterior composite layer 18 using, for example, roll coater 60 or other coating techniques such as spray coaters, extruders, or the like. It may also be applied to the top of the backing structure 14 by a spray coater, air knife, or other coating means if desired. The process line or lamination range of FIG. 2 may be used to also produce other structures such as shown, for example, in FIGS. 7, 12 and 14.

Aside from fused particles of, for example, rubber and foam, it is also contemplated that surface coverings of the present invention may incorporate backing structures of so called “rebond” foam wherein relatively small pieces or chips of scrap foam are formed into sheets with resilient binder between the foam pieces. FIG. 2A illustrates a processing line for the incorporation of, for example, such preformed rebond foam into a layered structure as described in relation to FIG. 1. In FIG. 2A, elements corresponding to those described in relation to FIG. 2 are designated by corresponding reference numerals with a prime.

The process illustrated in FIG. 2A is substantially identical to that described in relation to FIG. 2 with the exception that the deposited mass of particles and binder is replaced by a preformed sheet 14′ of particles and binder such as rebond foam or other bound particles or particle mixtures. In order to secure the exterior composite layer 18′ to this preformed sheet 14′, a coater 60′ is used to apply a layer of adhesive 50′ such as urethane, polyester, polyamide, or the like to the underside of the exterior composite layer 18′ prior to mating with the preformed sheet 14′. Upon entering the nip zone between the opposing belts 22′, 24′ the pressure and heat applied causes the foam pieces to partially compress. The binder between the foam particles may fuse the particles together in the partially compressed state thereby forming a stable backing structure of desired thickness and resilience. In this regard, greater compression may give rise to reduced levels of cushioning resilience. The exterior composite layer 18′ is concurrently bonded to the backing structure by the intermediate adhesive layer 50′. After formation, the resultant structure may be delivered to a tile cutter 31′ if it is to be used in a modular installation or accumulated on a roll (not shown) if it is to be used in extended length segments or to be cut later. The surface covering such as flooring, floor tile, or floor covering produced by the process of FIG. 2A may look like the product of FIG. 7 with or without the backing sheet 452.

An alternative process for use in forming the illustrated and described structures is shown in FIG. 2B. In FIG. 2B, elements corresponding to those described in relation to FIG. 2 are designated by corresponding reference numerals with a double prime. In this process the particle/binder composition P, B is delivered onto the carrier belt 22″ from deposit station 20″ downstream of a dam to form a build-up or puddle of the particle/binder composition at the nip between a doctor or compression roll 37″ and the carrier belt 22″. The compression roll 37″ presses the exterior composite layer 18″ with or without layer 17″ into the particle/binder mass while simultaneously controlling the thickness of the particle/binder material. During this compression, it may be preferred that the underlying portion of heating elements 26″ raises the temperature of the layers to initiate fusion bonding. The formed structure thereafter passes between the carrier belt 22″ and a downstream compression belt 24″ to complete joinder. After formation, the resultant structure may be delivered to a tile cutter 31″ if it is to be used in a modular installation or accumulated on a roll (not shown) if it is to be used in extended length segments or to be cut later.

It is contemplated that one or more friction enhancing materials or layers 15 may optionally be added to the bottom of backing 14 of surface covering element 10 of FIG. 1. Such friction enhancing materials are described, for example, in U.S. patent application Ser. No. 10/209,050 (US Published Application US2004/0022991) incorporated by reference herein. Preferably, such friction enhancing materials provide additional lateral grip and some vertical stick. Also, backing 14 and/or material 15 may include magnetic particles or material to provide a magnetic attraction to, for example, metal raised access flooring. Further, material 15 may be covered with a releasable, removable, cover sheet to provide a peel-n-stick surface covering product.

The present invention is also readily adaptable to structures requiring substantial levels of internal dimensional stability. One exemplary structure for a surface covering 110 intended to have such internal dimensional stability is illustrated in FIG. 3 wherein elements corresponding to those in FIG. 1 are designated by corresponding reference numerals increased by 100. As shown, in the embodiment of FIG. 3, the surface covering 110 incorporates a multi-layer stabilized backing structure 114 having a stabilizing layer 142 such as a woven or non-woven glass or fibreglass material disposed between opposing layers 140 of particles and binder, such as cork, foam or rubber particles held together with one or more binders as previously described. In addition, an added layer of adhesive 150 such as a hot melt urethane, polyester, polyamide or the like may be disposed between the exterior composite layer 118 and the upper surface of the backing structure 114. If desired, an optional backing sheet 152 of woven or non-woven construction may be placed across the underside either with or without an intermediate adhesive layer and an underlying friction enhancing material 115.

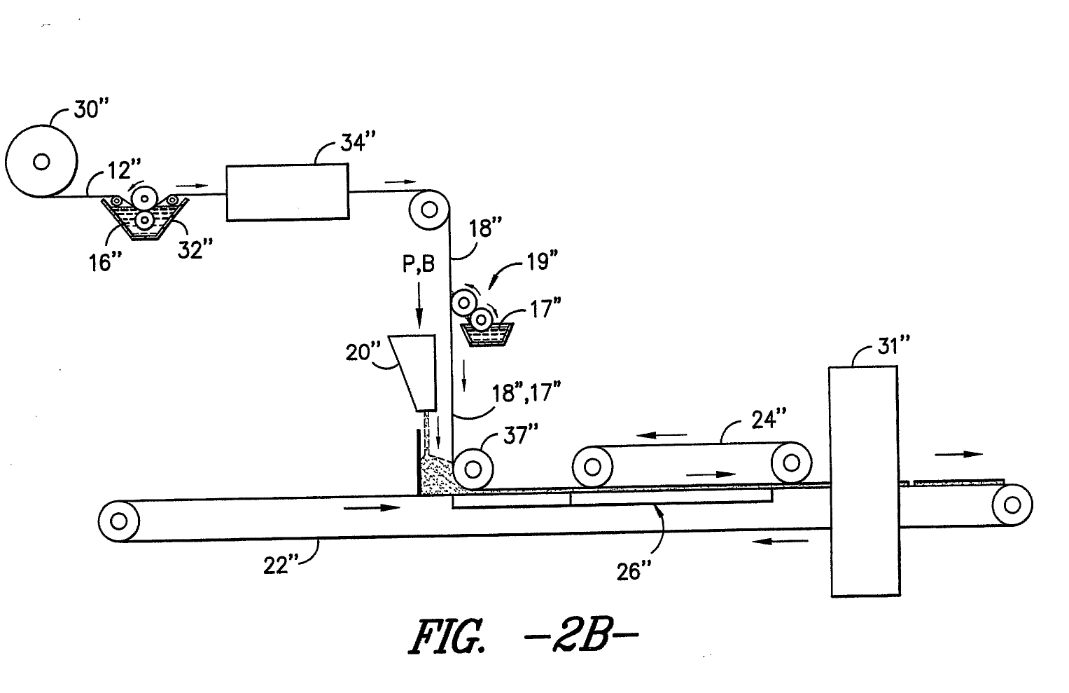

A process for making the surface covering 110 of FIG. 3 with a backing structure 114 incorporating layers of, for example, granulated particles of foam, cork and/or rubber will now be described with reference to FIG. 4, which is a schematic of an integrated processing line. In the illustrated process, a backing sheet 152 of woven or non-woven textile material is delivered in overlying relation to a carrier belt 122. By way of example only, the backing sheet is preferably a non-woven felt material incorporating polyester and/or polypropylene fibers in any desired ratio between 100% polyester to 100% polypropylene. A friction enhancing material 115 may be added after the product is formed, added to backing 152 prior to product formation, or the like. At a downstream location, a mixture of foam, rubber and/or cork particles P in blended relation with a desired binder B is delivered from a first deposit station 120 that blends and deposits the particles and binder onto the backing sheet 152. To aid in establishing a uniform deposit of particles and binder across the backing sheet 152 a doctor blade 123 or other suitable levelling device is positioned downstream of the first deposit station 120. A layer of stabilizing material 142 such as woven or non-woven glass is thereafter applied in juxtaposed relation across the particle and binder layer. Once the stabilizing layer 142 is in place, a mixture of foam, rubber and/or cork particles P in blended relation with a desired binder B is delivered onto the stabilizing layer 142 from a second deposit station 121 that blends and deposits the particles and binder. To aid in establishing a uniform deposit of particles and binder a doctor blade 125 or other suitable levelling device is positioned downstream of the second deposit station 121. A deposit head of deposit stations 120, 121 of FIGS. 4 and 20 of FIG. 2 may be, for example, moved back and forth across belts 122 and 22, respectively, to spread the particle and binder mixture across the belt.

The carrier belt 122, like belt 22, is made, for example, of PTFE-coated woven glass fabric to prevent the applied materials from sticking to it. In use, the carrier belt 122 advances in the direction of the arrows. This movement may be either stepwise or continuous depending upon the nature of the product being formed. As illustrated, the carrier belt 122 is disposed in opposing relation to motor driven compression belt 124 which moves in reverse angular relation to the carrier belt 122 to establish a nip zone between the belts in the vicinity of heating (or cooling) elements 126. Materials deposited on the carrier belt 122 thus undergo a degree of compression between the carrier belt 122 and the compression belt 124 while simultaneously being heated and/or cooled.

In the illustrated process, a fabric forming the textile show surface 112 is conveyed from a roll 130 through a first coater 132 such as a submersion roll coater or the like wherein the film forming composition 116 is applied in saturating relation to the textile show surface fabric. The film-forming composition is preferably a liquid urethane such as is readily available for coating hard wood floors and the like although acrylics, polyesters, polyamides, and other suitable protective film forming compositions may likewise be utilized if desired. After exiting the coater 132, the saturated fabric is preferably then passed through a curing station 134 such as a heater or the like to cure the applied film forming composition 116 thereby forming the exterior composite layer 118. The exterior composite layer 118 is then delivered to a second coater 160 such as a reverse roll coater or the like for application of the adhesive layer 150 to the underside surface. The surface composite 118 may then pass by a coater 119 such as a reverse roll coater to apply, for example, an additional wear layer, stain resist layer, soil resist layer, additional layer of composition 116, or the like. The fabric with the cured coating 116 and applied adhesive 150 and optional layer 117 is then applied in overlying relation to the upper layer of particle/binder composition for subsequent compression and heating and/or cooling between the carrier belt and the compression belt. Of course, it is to be understood that the coating of the show surface fabric need not be carried out in the same processing line as the heated compression. In fact, such steps are likely to be carried out in separate processing lines to facilitate processing freedom. Hence, the exterior composite 118 may be supplied in roll form with or without Layers 150, 117 and/or the like. It is contemplated that one or more of Coaters 132, 160, and 119 may or may not be used for a particular structure.

After the exterior composite layer 118 is oriented on top of the particle binder composition, the pressure and heat (and/or cooling) applied between the opposing belts 122, 124 causes the binder to fuse the particles together thereby forming a stable backing structure 114 adhered to both sides of the stabilizing layer 142. In this regard, the applied pressure is preferably in the range of about 0.01 to about 50 pounds per square inch preferably about 0.1 to about 20 pounds per square inch and the temperature is preferably in the range of about 300° to about 375° Fahrenheit. The exterior composite layer 118, 117 is concurrently bonded to the backing structure 114 by the binder in combination with the applied adhesive 150. After formation, the resultant structure may be delivered to a tile cutter 131 if it is to be used in a modular installation or accumulated on a roll (not shown) if it is to be used in extended length segments or to be cut later.

Aside from fused particles of cork, rubber and foam, it is also contemplated that surface coverings of the present invention may incorporate backing structures of, for example, so called “rebond” foam wherein relatively small pieces or chips of scrap foam are formed into sheets with resilient binder between the foam pieces. FIG. 4A illustrates a processing line for the incorporation of such preformed rebond foam or other particles into a layered structure as described in relation to FIGS. 3, 2A, and 11. In FIG. 4A, elements corresponding to those described in relation to FIG. 4 are designated by corresponding reference numerals with a prime.

The process illustrated in FIG. 4A is substantially identical to that described in relation to FIG. 4 with the exception that the deposited layers of particles and binder are replaced by preformed sheets 140′ of particles and binder such as rebond foam. In the illustrated process, layers of adhesive such as urethane adhesive, hot melt adhesive, or the like are applied between each of the preformed sheets 140′ of rebond foam and the adjacent layers by coaters 161′ to facilitate bonding. Upon entering the nip zone between the opposing belts the pressure and heat (and/or cooling) applied causes the foam pieces to partially compress. The binder between the foam particles may fuse the particles together in the partially compressed state thereby forming a stable backing structure of desired thickness and resilience. In this regard, greater compression may give rise to reduced levels of cushioning resilience. The exterior composite layer 118″ is concurrently bonded to the backing structure by the binder of the rebond sheet in combination with the applied adhesive 150′. After formation, the resultant structure may be delivered to a tile cutter 131′ if it is to be used in a modular installation or accumulated on a roll (not shown) if it is to be used in extended length segments or to be cut later.

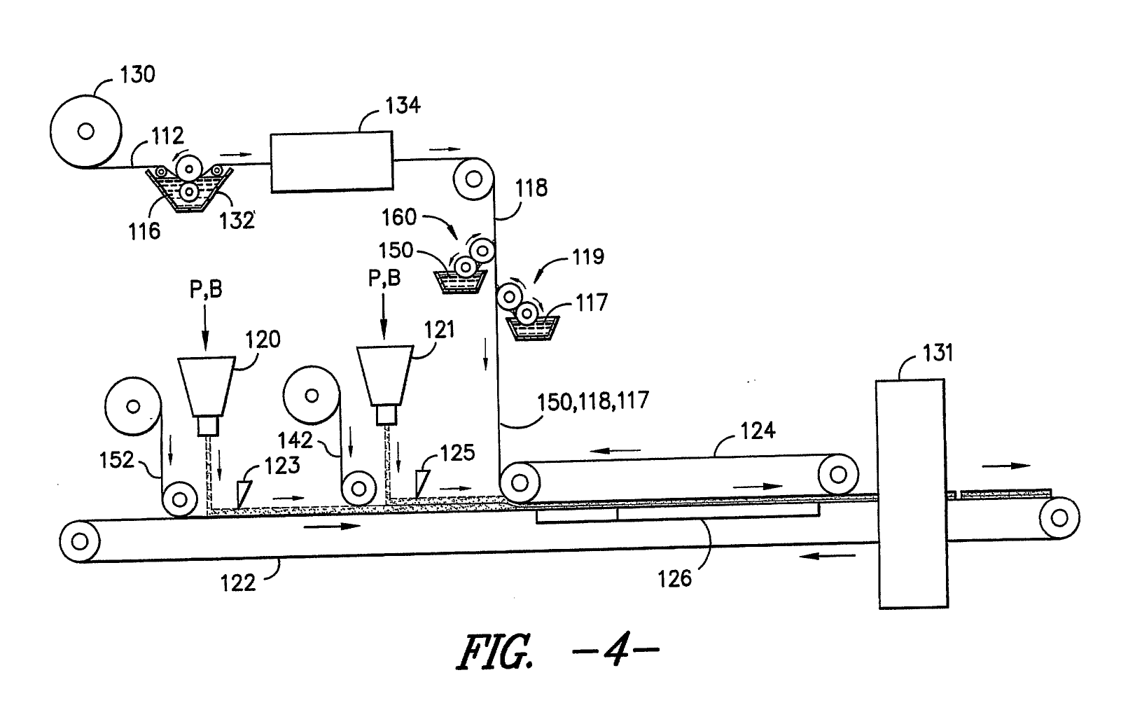

Of course it is to be understood that any number or other embodiments may be utilized for the surface covering depending upon contemplated use and performance requirements. By way of example only, one contemplated alternative construction is illustrated in FIG. 5 in which elements corresponding to those previously described are designated by like reference numerals within a 200 series. As will be appreciated, the surface covering 210 in FIG. 5 is of substantially the same construction as described in relation to FIG. 1 but with the addition of a backing sheet 252 of, for example, a textile or fabric, such as a woven or non-woven fibrous material disposed across the underside. In this construction, the backing sheet 252 is preferably held in place by the binder securing particles together in the backing layer 214. However, an additional adhesive layer may be used if desired. It is contemplated that such a structure may be formed by a process as illustrated and described in relation to FIG. 2 or FIG. 4 if the backing structure 214 is of a ground material such as crumb foam, rubber or cork or by a process as described in relation to FIG. 4A if the backing structure is a sheet of preformed particles and binder, such as rebonded foam or the like. In such a practice, the roll feeding the stabilizing material and one of the deposit stations (or one of the rolls feeding rebond sheet) of FIG. 4 or 4A is deactivated.

Another contemplated construction is illustrated in FIG. 6 wherein elements corresponding to those previously described are designated by like reference numerals within a 300 series. In this construction a stabilizing layer 342 such as woven or nonwoven glass or the like is adhesively bonded below the saturated show surface material by a layer of adhesive 350 such as a hot melt urethane or the like. It is contemplated that such a structure may be formed by a process as illustrated and described in relation to FIG. 4 if a ground backing material such as crumb foam, rubber or cork is used or by a process as described in relation to FIG. 4A if a sheet of preformed rebonded foam or the like is used. In such a practice the second deposit station (or downstream roll feeding rebond sheet) is simply deactivated. The resulting structure provides substantial internal dimensional stability and may be particularly suitable for articles such as carpet tile, floor tile, stabilized roll goods, and the like.

Another contemplated construction is illustrated in FIG. 7 wherein elements corresponding to those previously described are designated by like reference numerals within a 400 series. In this construction, a particle/binder layer of ground particles or preformed sheet construction, for example, a rebond foam sheet construction is adhesively bonded below the saturated show surface material by a layer of adhesive 450 such as a hot melt urethane or the like. It is contemplated that such a structure may be formed by a process as illustrated and described in relation to FIG. 2, 4 or 4A. For example, such a construction may be formed by the process of FIG. 4 if a ground backing material such as crumb rubber or cork is used or by a process as described in relation to FIG. 4A if a preformed sheet of, for example, rebonded foam is used. In such a practice the roll feeding the stabilizing material and the second deposit station (or downstream roll feeding rebond sheet) is simply deactivated.

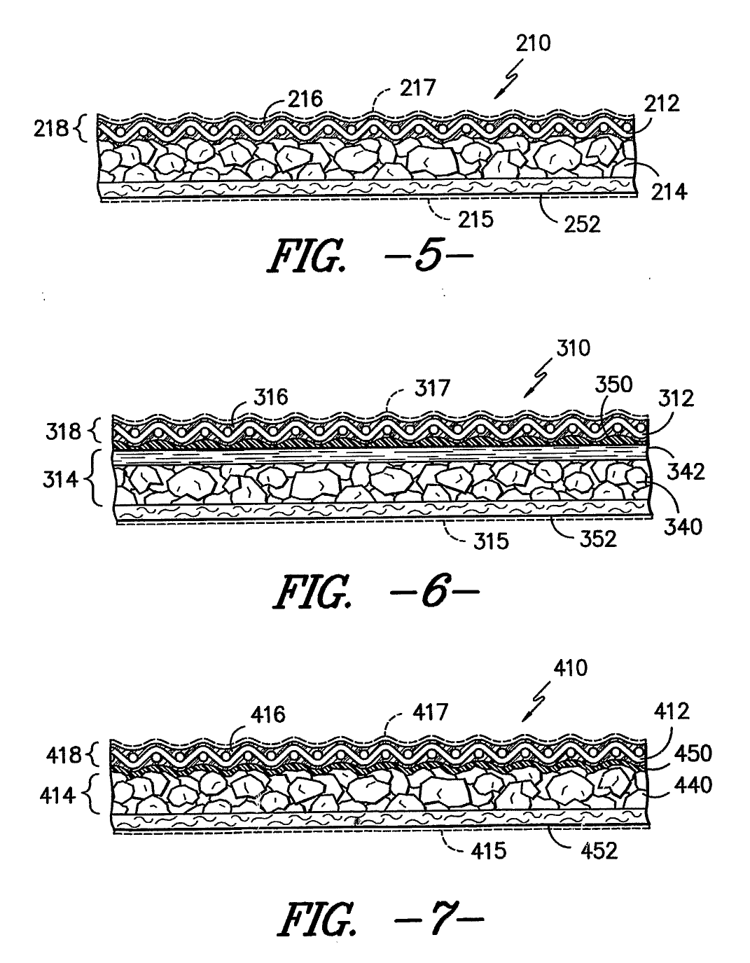

Another contemplated construction is illustrated in FIG. 8 wherein elements corresponding to those previously described are designated by like reference numerals within a 500 series. As will be appreciated, this construction is a modification of that in FIG. 7 wherein the adhesive layer 550 is removed and an adhesive layer 554 is positioned between the backing structure 514 and a fibrous backing sheet 552. It is contemplated that such a structure may be formed, for example, by slightly modifying the process illustrated and described in relation to FIG. 4 if a ground backing material such as crumb rubber or cork is used or as described in relation to FIG. 4A if a preformed sheet of, for example, rebonded foam is used. In such practices an adhesive coater is placed upstream of the first deposit station (or first roll feeding preformed rebond) so as to coat a layer of adhesive across the top of the fibrous backing Layer 552 prior to mating with upper layers. The adhesive coater treating the exterior composite layer, the roll feeding the stabilizing material and the second deposit station (or downstream roll feeding rebond sheet) are simply deactivated. Alternatively, deposit station 120 of FIG. 4 may be converted to a roll coater for applying adhesive 554 to backing 552. Adhesive layer 554 may be helpful in bonding backing 514 to, for example, a polyester or polypropylene nonwoven or felt backing 552.

Another contemplated construction is illustrated in FIG. 9 wherein elements corresponding to those previously described are designated by like reference numerals within a 600 series. As will be appreciated, this construction is a modification of that in FIG. 7 or FIG. 8 wherein an adhesive layer 650 is disposed between layer face 618 and backing 640 and an adhesive layer 654 is disposed between the backing layer 640 and a fibrous backing sheet 652. It is contemplated that such a structure may be formed by slightly modifying the process illustrated and described in relation to FIG. 4 if a ground backing material such as crumb rubber or cork is used or as described in relation to FIG. 4A if a sheet of rebonded foam is used. In such practices an adhesive coater is placed upstream of the first deposit station (or first roll feeding preformed rebond) so as coat a layer of adhesive across the top of the fibrous backing layer prior to mating with upper layers. The roll feeding the stabilizing material and the second deposit station (or downstream roll feeding rebond sheet) are simply deactivated. Alternatively, deposit station 120 of FIG. 4 may be converted to a roll coater for applying adhesive 654 to textile backing 652. The structure 610 of FIG. 9 is especially suited for use of a preformed sheet of particles and binder as backing layer 640.

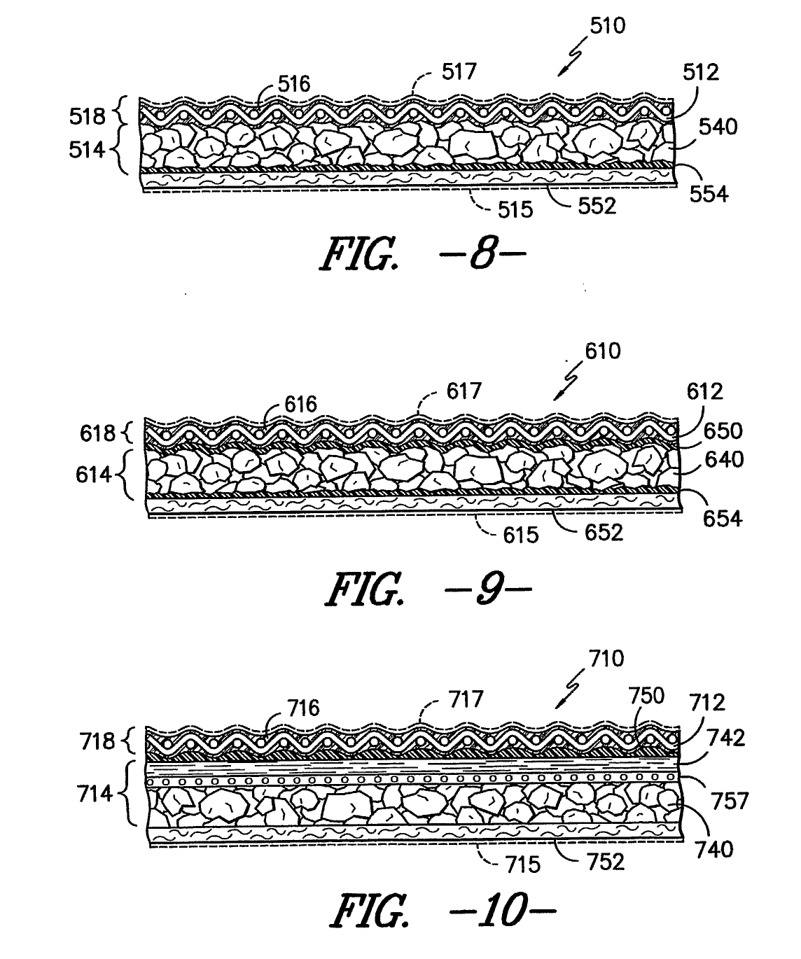

Another contemplated construction is illustrated in FIG. 10 wherein elements corresponding to those previously described are designated by like reference numerals within a 700 series. As will be appreciated, this construction is a modification of that in FIG. 6 wherein a scrim layer 757 such as polyester, polypropylene, glass, or the like woven or nonwoven mesh or net-like material (scrim) is disposed adjacent to the glass. It is contemplated that such a structure may be formed by a process as illustrated and described in relation to FIG. 4 if a ground backing material such as crumb rubber or cork is used or by a process as described in relation to FIG. 4A if a sheet of rebonded foam is used. In such a practice a scrim delivery roll is placed upstream of the roll delivering stabilizing material and the second deposit station (or downstream roll feeding rebond sheet) is deactivated. The resulting structure provides substantial internal dimensional stability and may be particularly suitable for articles such as carpet tile, floor tile, modular products, and the like. For example, the scrim 757 may balance any shrinkage in the face material 712 to provide for a flat or slightly domed product. The additional stabilizing layer 757 may facilitate the removal of textile backing 752, use of a lighter face fabric 712, use of less composition 716 or 717, provision of a more durable, printable product, and/or the like.

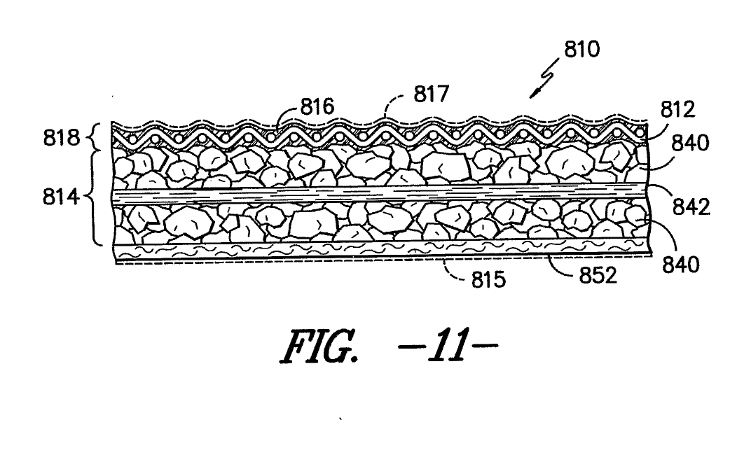

Another contemplated construction is illustrated in FIG. 11 wherein elements corresponding to those previously described are designated by like reference numerals within an 800 series. As will be appreciated, this construction is a modification of that in FIG. 3 wherein no additional adhesive is disposed between the exterior composite Layer 818 and underlying layers. It is contemplated that such a structure may be formed by a process as illustrated and described in relation to FIG. 4 if a ground backing material such as crumb rubber or cork is used or by a process as described in relation to FIG. 4A if a preformed sheet of, for example, rebonded foam is used. In such practices the adhesive coater treating the exterior composite layer is preferably simply deactivated.

As will be appreciated, if desired, additional layers of adhesive such as hot melt urethane, polyester and/or polyamide or the like may be added at one or more of the intersections between any of the layers in any of the illustrated embodiments. Thus, by way of example, a layer of adhesive may be added between the backing sheet and the adjacent backing layer and/or between the lower backing layer and the stabilizing layer (if utilized) and/or between the stabilizing layer (if utilized) and the overlying backing layer (if present). Likewise, it is contemplated that in any of the illustrated and/or described embodiments that the structure may be formed with or without a fibrous backing sheet. Also, additional binder may be added to the surface of any preformed particle sheets such as rebond foam. Further, additional top layer (17) or additional bottom layer (15) may or may not be added to a particular construction.

One contemplated benefit of the constructions of the present invention is the ability to incorporate large percentages of recycled, renewable, recyclable, or other environmentally friendly materials, for example, waste products such as recycled weather stripping, recycled mats, recycled tires, carpet waste, used flooring, and the like. Also, renewable resources such as cork or wood may be used alone or in combination with recycled materials. By way of example only, recycled filler materials such as carpet may be ground up and blended with rubber particles (and/or cork particles) and binder prior to being deposited in the desired layered relation. In such a process, the carpet waste does not undergo melting but rather forms a constituent of the resilient matrix forming the backing. Thus, relatively large amounts of carpet waste, used flooring, or the like, may be incorporated without negatively impacting resiliency since the individual rubber particles (and/or cork particles) are not melted.

Another benefit of the constructions of the present invention is that the utilized flat fabric in the exterior composite layer makes up a fairly small percentage by weight of the final structure. This weight percentage will normally be less than about 25% and will preferably be about 10% or less. Thus, the present surface covering product itself may be ground up and recycled as new backing material numerous times without undue contamination from fibrous constituents. In one example, the particle binder mixture is made up of one-third cork particles, one-third rubber particles, and one-third recycled surface covering particles. The one-third proportion can be based on either weight or volume. Binder such as MDE binder bonds the three different types of particles together.

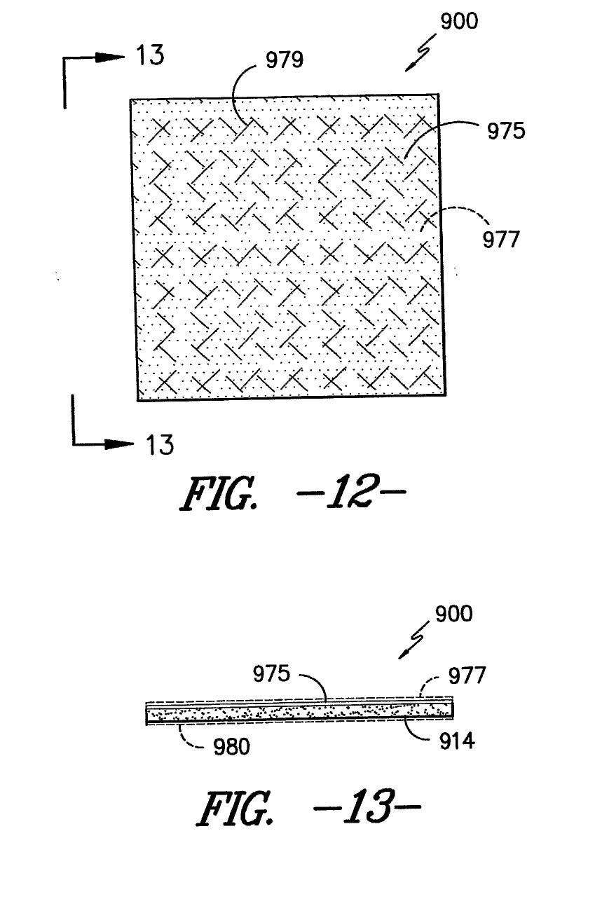

As previously indicated, one contemplated use of the constructions is in the form of a surface covering tile or mat such as a flooring tile or the like. An exemplary tile 900 having a decorative show surface 975 defined by an exterior composite layer incorporating a decorative textile layer as previously described and overlying a particle backing 914 is illustrated in FIGS. 12 and 13. Of course, it is to be understood that while a single layer particle backing 914 has been shown for simplicity, any of the described backing constructions may likewise be used if desired. Tile 900 may also include an optional cover layer 977, texturing 979 such as embossing, and a friction enhancing layer 980. Likewise, while a square tile is illustrated, it is contemplated that other geometries such interlocking dovetails, chevrons and the like may also be utilized.

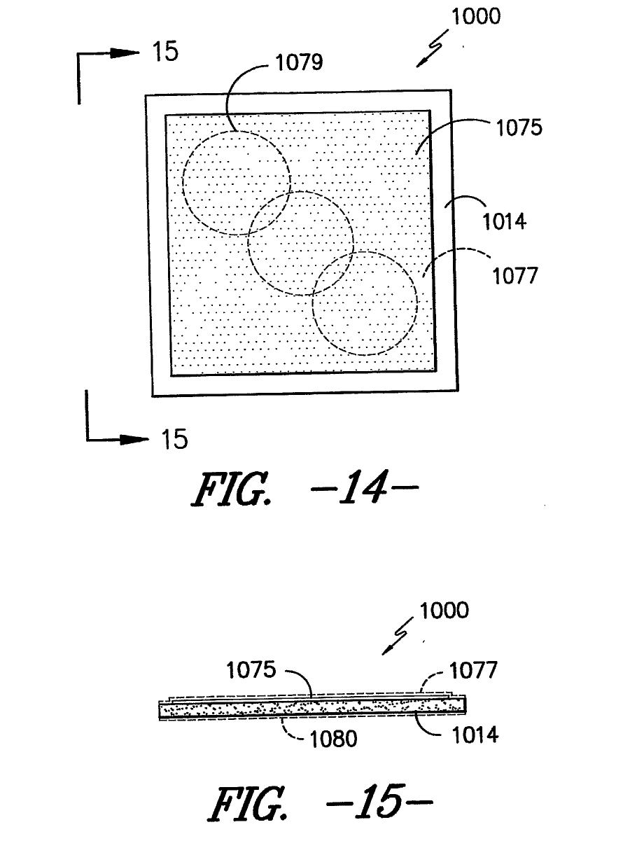

It is also contemplated that the materials forming the backing structures may themselves be used to provide a portion of an aesthetically pleasing show surface. By way of example only, in FIGS. 14 and 15 a tile or mat construction 1000 is illustrated having a decorative show surface 1075 defined by an exterior composite layer incorporating a decorative textile as previously described and overlying a particle backing 1014. As shown, a portion of the particle backing 1014 extends outboard of the exterior composite layer to define a decorative border. Such a construction may be useful in facilitating the substantially placement of tiles relative to one another across a surface since all edge borders will be of a generally matching appearance. Also, tile 1000 may include an optional top layer 1077, texturing 1079 such as embossing, and a friction enhancing bottom layer 1080.

The materials forming the backing structures may also be used to provide a portion of an aesthetically pleasing show surface by using show surface fabric constituents of relatively open weave or knit construction (including mesh or net-like scrims) such that the backing is visible through the show surface fabric. Such open fabrics may be used alone or in combination with outboard borders. The bottom surface of any of the structures, constructions, or products of the present invention may also be textured such as by embossing to, for example, enhance surface friction or the like.

In accordance with one possible embodiment of the present invention, the construction of a textile face and a backing of at least one layer of agglomerated, adjoined particles are cured, cut into floor tile blanks, collared, printed or dyed, then the face is coated with a film-forming composition, and cured to form a clear, transparent or at least translucent film. The textile face, backing, and/or film may be textured, embossed, or the like prior to, during, or following coloration, printing, or dyeing.

It is usually easier to print or dye in register by printing or dyeing tile blanks or modular blanks as contrasted to printing or dyeing in broadloom form. A backed floor tile blank (textile face, particle/binder backing, with or without an additional stabilizing layer, adhesive layer, textile backing, friction enhancing backing, and/or the like) with a light color or white textile face adapted to be colored, printed, dyed, or the like is adapted to be colored, dyed, printed, textured, treated, embossed, and can have, for example, an image, design or pattern applied thereto with relative precision (for example, by placing a square tile blank in a jig) to produce, for example, a floor tile with an image, pattern, or design which will register with an adjacent image, pattern, or design of an abutting floor tile in a floor tile installation. In this manner, a large image, pattern or design can be split up into a number of parts with each part on a separate tile. Alternatively, a tile pattern that is intended to mate with at least certain elements of an adjacent tile pattern can do so with precision and in registration to provide a very pleasing appearance to the overall installation.

Similarly, a tile blank or modular blank with a textile show surface saturated with a protective coating and a particle/binder backing may be cured and then colored, printed, dyed, and/or the like by, for example, a sublimation process (for example, dye sublimation printing, ink sublimation printing, inkjet sublimation printing, or the like) where the dye, ink, image, design, pattern, or the like passes through the protective film over the textile face and produces, for example, an image, coloration, design, or pattern visible through the transparent or translucent protective film. Sublimation is usually done on a polyester, polymer, or polymer coated surface.

For example, at high temperatures, solid dyes in the sublimation print can convert into a gas without becoming a liquid. The high temperature also opens the pores of the polymer film or fabric and allows the gas to enter. When the item is removed from the heat, the temperature drops, and the polymer pores close and the gas reverts to a solid state and becomes a part of the polymer film or fabric. Done correctly, it cannot be washed out or come off, unless the actual fibers or coating is damaged.

Most inkjet sublimation is done on white materials (substrates). The reason for this is because the inks are actually transparent, when sublimated, and need a background to show up. White is the ideal background because it does not clash with the colors. Indeed, the white background actually enhances the colors.

In accordance with selected embodiments of the present invention, a white textile, white coated textile, or white coating or film acts as the white substrate or background below a clear or transparent polymer coating such as a polyester coating for sublimation printing of an image, design or pattern on the surface covering of the present invention. Also, one or more additional transparent coatings, films, or wear layers may be added over the polyester or polymer coating or film.

In accordance with at least one embodiment of the present invention, the face and/or backing of the surface covering of the present invention meets or exceeds industry standards of, for example, flammability, smoke, toxicity, soil protection, antimicrobial, odor, VOC, smoke density, pill test, lightfastness, crocking, static electricity, dimensional stability, Aachen test, dye fastness, durability, caster chair test, face weight, height, flexibility, size, cup, curl, bow, bias, skew, height variation, dimensional variation, stain protection, soil resistance, stain resistance, cleanability, commercial rating, residential rating, cushion, resilience, drape, seamability, appearance retention, compression, compression set, recycled content, recyclable content, renewable material content, and/or other industry standards, environmental standards, test ratings, and/or the like. For example, floor covering industry standards and/or specifications, more particularly, commercial flooring standards, residential flooring standards, institutional flooring standards (such as hospital, education and/or government standards), hospitality flooring standards, retail flooring standards, and/or the like.

In accordance with at least one embodiment of the present invention, it is preferred that the particles and/or crumbs in the particle/binder backing structure or layer be about 6 mm or less (powder or granules).

The particle/binder backing of at least one embodiment of the present invention is cured at about 100 psi (pounds per square inch) or less, preferably 50 psi or less, more preferably 25 psi or less, most preferably 10 psi or less. A low pressure cured particle/binder backing having some voids between the crumb (particles) and having, for example, crumb ranging in size mainly from about 2 mm to about 6 mm provides lateral grip with smooth and even carpeted surfaces. This lateral grip provides surface coverings, for example, flooring which tends not to creep or walk. Floor tiles of the present invention having this lateral grip tend to stay in place after installed even without full spread adhesive installation, releasable adhesive installation, double sticky tape installation, and even free-lay or adhesive free installation.

The particles or crumbs of the particle/binder backing of at least certain embodiments of the present invention may be selected from recycled, recyclable, renewable, waste, by-product, reclaimed, and/or virgin materials.

It is preferred to use recycled, recyclable, and/or renewable materials when possible. For example, recycled flooring, recycled foam, recycled rubber, recycled cork, cork, wood, and combinations thereof, are preferable. Recycled flooring such as recycled carpet, recycled carpet tile, recycled waste carpet, recycled carpet, recycled trim waste, recycled carpet production waste, and the like can be processed to produce particles or crumbs of less than about 20 mm, preferably less than about 15 mm, more preferably less than about 10 mm, and most preferably less than about 6 mm (powder or granules). Although post consumer recycled content may be preferred, post industrial recycled content, renewable material, recyclable material, and other environmental friendly materials may be used.

While the present invention has been illustrated and described in relation to certain potentially preferred embodiments and practices, it is to be understood that the illustrated and described embodiments and practices are illustrative only and that the present invention is in no event to be limited thereto. Rather, it is fully contemplated that modifications and variations to the present invention will no doubt occur to those of skill in the art upon reading the above description and/or through practice of the invention. It is therefore intended that the present invention shall extend to all such modifications and variations as may incorporate the broad aspects of the present invention within the full spirit and scope of the following claims and all equivalents thereto.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which, for clarity, are described in the context of separate embodiments, may also be provided in combination in a single embodiment. Conversely, various features of the invention which are, for brevity, described in the context of a single embodiment, may also be provided separately or in any suitable sub-combination.

1. A surface covering comprising an exterior composite layer defining a show surface disposed in overlying relation to a single or multi-layer particle backing, wherein the exterior composite layer comprises a decorative textile layer optionally saturated with a protective film-forming composition and wherein the particle backing comprises an agglomerated mass of particles bonded together in adjoined relation.

2. The invention of claim 1, further comprising a fibrous backing sheet disposed across an underside portion of the particle backing.

3. The invention of claim 1, wherein the surface covering is a tile.

4. The invention of claim 1, wherein the decorative textile layer is a woven fabric.

5. The invention of claim 4, wherein the woven fabric is formed of polyester.

6. The invention of claim 1, wherein the decorative textile layer is a knit fabric.

7. The invention of claim 6, wherein the knit fabric is formed of polyester.

8. The invention of claim 1, wherein the particle backing is resilient.

9. The invention of claim 1, wherein the show surface is disposed in overlying relation to a multi-layer backing.

10. The invention of claim 9, wherein the particle backing is bonded together in adjoined relation in combination with at least one stabilizing layer.

11. The invention of claim 10, wherein said stabilizing layer is at least one of woven or nonwoven glass.

12. The invention of claim 11, further comprising a fibrous backing sheet disposed across an underside portion of the particle backing.

13. The invention of claim 11, wherein the surface covering is a tile.

14. The invention of claim 1, wherein the decorative textile layer is a nonwoven fabric or textile.

15. The invention of claim 14, wherein the nonwoven fabric is formed of polyester.

16. The invention of claim 10, wherein the backing is resilient.

17. A method of producing a surface covering with a textile surface and a particle backing, comprising the steps of: mixing particles, for example particles of rubber and/or foam and/or cork with binder optionally with the addition of one or more fillers, agents or compounds; depositing the particle/binder mixture in a layer; placing an optionally coated or saturated textile surface material on the deposited particle/binder layer to form a multi-layer structure; pressing the multi-layer structure while setting the binder with, for example, heat so that the particles are consolidated to form a particle backing optionally including voids between the pressed particles, and wherein the optionally coated textile surface material is bonded to the particle backing.

18. The method of claim 17, wherein the optionally coated textile surface material is at least one of printed or dyed before or after it is coated.

19. The method of claim 18, wherein the optionally coated textile surface material is sublimation printed.

20. The method of claim 17, wherein one or more additional wear layers are added over the optionally coated textile surface material.
